(19) United States
(12) Patent Application Publication
(10) Pub. No.: US 2006/0006038 A1
(43) Pub. Date: Jan. 12, 2006

(54) Extendible musical instrument cable

(76) Inventor: Timothy E. Beverlin, Ronks, PA (US)

Correspondence Address: LITMAN LAW OFFICES, LTD, PO BOX 15035, CRYSTAL CITY STATION, ARLINGTON, VA, 22215, US

(21) Appl. No.: 10/886,706

(22) Filed: Jul. 9, 2004

(51) Int. Cl. H02G 11/00

(52) U.S. Cl. 191/12.2 R

(57) ABSTRACT

The extendible musical instrument cable has a housing having a pair of sidewalls and a peripheral wall defining, preferably, a flat cylindrical housing. An opening is defined in the peripheral wall. A mounting loop is disposed on the housing. A cable reel is rotatably mounted between the sidewalls of the housing, the cable reel being spring-biased in a first rotational direction. A ratchet assembly controls the rotation of the cable reel against the spring bias. A fixed electrical cable, terminated with a male phone plug for connection to a musical instrument or to a piece of electronic equipment, extends from the housing. The fixed electrical cable is electrically connected to an extendible electrical cable that is coiled about the reel. A free end of the extendible electrical cable extends through the opening in the peripheral wall of the housing, and is terminated by a male phone plug.

### BACKGROUND OF THE INVENTION

1. Field of the Invention

The present invention relates to electrical cables. More specifically, the invention is an extendible musical instrument cable for connecting musical instruments to an amplifier or other sound equipment.

2. Description of the Related Art

Electric and electronic musical instruments, such as electric guitars, electronic keyboards and synthesizers, and numerous other kinds of instruments, are commonplace, along with associated electronic equipment including amplifiers, speakers, public address (PA) systems, microphones, recording equipment, and a litany of other devices.

Electrical cables interconnect instruments and associated electronic equipment. Most typically, an electronic musical instrument is connected to associated electronic equipment with a cable having a male phone plug at each end. For example, an electric guitar has a phone jack within its body, and a phone jack is disposed on the housing of an amplifier. The male phone plug at one end of a cable is plugged into the electric guitar, and the male phone plug at the other end of the cable is plugged into the amplifier.

It is desirable to provide a musical instrument cable of sufficient length to accommodate a variety of equipment arrangements or setups, from equipment arranged across a large stage to equipment stacked at close quarters in a small recording or rehearsal studio. However, excessive lengths of cable present problems in that the excessive cable may be unattractive, may be prone to entanglements, and may present a tripping hazard as excessive lengths of numerous cables accumulate. Loose cables must be coiled for storage or transportation after use.

It is, therefore, desirable to provide musical instrument cable along with a means for storing and organizing the cable. A simple solution is to provide an elongated cable coiled about a spool, whereby an appropriate length of the cable for a given use is uncoiled from the spool. The length of unused cable remains coiled on the spool. However, the task still remains to manually uncoil a desired length of cable from the spool, and then manually recoil the cable back onto the spool.

U.S. Pat. No. 3,585,324, issued on Jun. 15, 1971 to A. Renndorfer et al., discloses a cable reel having a length of cable terminated at a free end with a plug for connection into a socket or receptacle of a remote device. The reel itself has a female electrical receptacle in connection with the cable. This represents a common configuration of cable reels that function in an “extension cord” manner, receiving the plug of a cord or cable in the receptacle and providing a length of cable that may be removed from the reel to extend to the remote device.

U.S. Pat. No. 4,713,497, issued on Dec. 15, 1987 to J. Smith, discloses a self-storing cord and reel assembly for shielded cables. The assembly has a housing that contains a spring-biased cable reel. A length of cable is coiled about the reel such that the cable may be pulled from the reel against the spring bias. A ratchet mechanism locks the reel in place, allowing an amount of cable to be removed from the reel. The ratchet mechanism is releasable to allow the cable to be rewound onto the reel by the spring. Thus, a length of cable may be pulled from the reel, and rewound automatically by the spring. As with the Renndorfer device discussed above, connection is made to the cable by a female receptacle disposed in the housing and in electrical connection to the cable.

U.S. Pat. No. 5,671,833, issued on Sep. 30, 1997 to M. Edwards et al., discloses a retractable coaxial cable device having a length of coaxial cable that is extendible from a reel disposed within a housing. The cable is rewound using a hand crank, and the device includes an electrical connector fixed to the housing for connection to the coaxial cable.

Such “extension cord” type cable reels are disadvantaged, however, by the need to provide an extra cord for connection to the cord reel. Because a typical musical instrument cable has a male phone plug on each end, it is desirable to have a cable reel configuration that includes, instead of a female receptacle, a length of cable having a male phone plug for compatibility with musical instrument connector ports.

U.S. Pat. No. 5,913,487, issued on Jun. 22, 1999 to M. Leatherman, discloses a retractable cable system featuring multiple cable retractors within a single, rack-mountable housing. Each of the individual cable retractors contains an electrical cable having a fixed end and a retractable end, the fixed ends of each of the retractors extending from the housing for connection to a nearby fixture, such as a rack mounted public address (PA) system. While such a retractable cable system is well suited for its intended purpose in providing retractable cables for a rack-mounted equipment environment, it is disadvantageous for a single performer or for a distributed arrangement of musical instruments and electrical accessories because of its relative size and weight.

U.S. Pat. No. 6,616,080, issued on Sep. 9, 2003 to B. Edwards et al., discloses a retractable cord device for an earphone used with a cell phone. The device provides two separate spools for earphone and connector ends of a cord.

None of the above inventions and patents, taken either singly or in combination, is seen to describe the instant invention as claimed. Thus, an extendible musical instrument cable solving the aforementioned problems is desired.

### SUMMARY OF THE INVENTION

The extendible musical instrument cable comprises a housing having a pair of parallel sidewalls and a peripheral wall defining, preferably, a flat cylindrical housing. An opening is defined in the peripheral wall. A mounting loop is disposed on the housing, preferably located on the peripheral wall. A cable reel is rotatably mounted between the sidewalls of the housing, the cable reel being spring-biased in a first rotational direction. A ratchet assembly controls the rotation of the cable reel in a direction opposite the first rotational direction.

A fixed length electrical cable extends from one of the sidewalls. One end of the fixed length electrical cable is terminated with a male phone plug for connection to a musical instrument or to a piece of electronic equipment, while the other end is electrically connected to an extendible electrical cable coiled about the reel. A free end of the extendible electrical cable extends through the opening on the peripheral wall of the housing, and is terminated by a male phone plug.

The extendible musical instrument cable allows for connections between electric and electronic musical instruments and associated electronic equipment without the need for additional adapter cables. The mounting loop allows the extendible musical instrument cable housing to be secured to, or adjacent to, a musical instruments or associated electronic equipment so that as the extendible cable is pulled from the housing, the fixed cable end is not pulled from its connection to the musical instruments or associated electronic equipment.

These and other features of the present invention will become readily apparent upon further review of the following specification and drawings.

### BRIEF DESCRIPTION OF THE DRAWINGS

FIG. 1 is a perspective view of an extendible musical instrument cable according to the present invention.

FIG. 2 is an exploded view of the extendible musical instrument cable according to the present invention, the spring being omitted.

FIG. 3 is a section view drawn along lines 3-3 of FIG. 1.

FIG. 4A is a perspective view showing the contact side of a contact ring insert for a sidewall of the extendible musical instrument cable according to the present invention.

FIG. 4B is a perspective view showing the wiring side of the contact ring of FIG. 4A.

Similar reference characters denote corresponding features consistently throughout the attached drawings.

### DETAILED DESCRIPTION OF THE PREFERRED EMBODIMENT

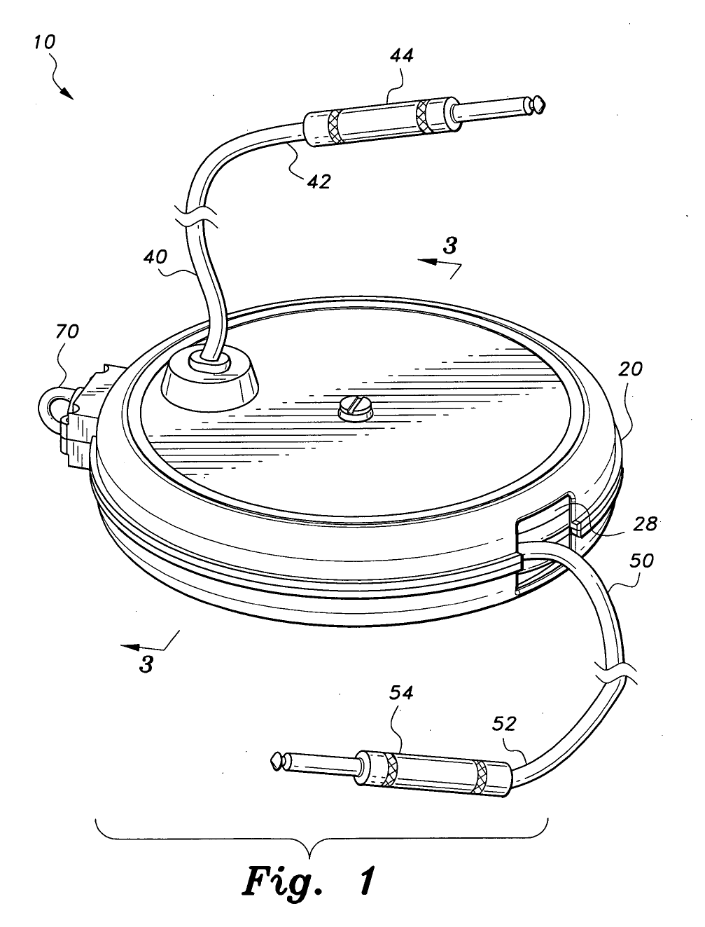

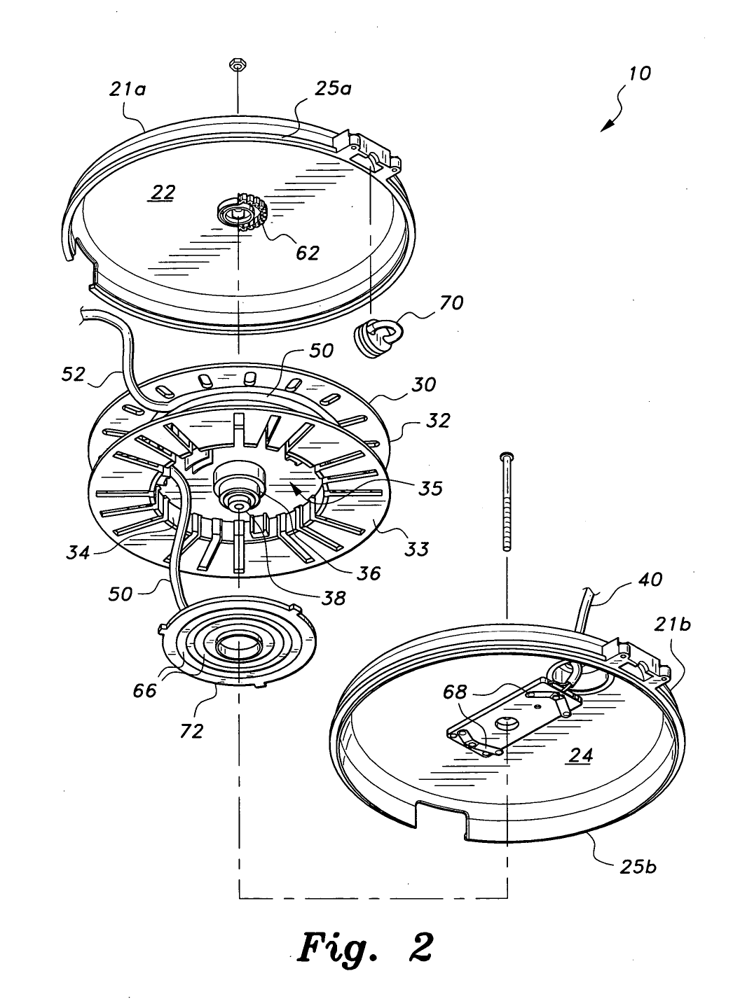

The present invention is an extendible musical instrument cable, referred to generally as 10 in the drawings. Referring to FIGS. 1 and 2, the extendible musical instrument cable 10 comprises a housing 20 containing an extendible cable 50 coiled about a reel 30. A free end 52 of the extendible cable 50 extends from an opening 28 defined in the housing 20, and is terminated with a phone plug 54. A fixed cable 40 having a free end 42 that is terminated with another phone plug 44 extends from the housing 20. The fixed cable 40 is in electrical connection with the extendible cable 50. A mounting loop 70 is disposed on the housing 20. In use, the extendible musical instrument cable 10 is connected between a musical instrument and an associated piece of electronic equipment, or between two pieces of equipment. Typically, the phone plug 44 on the fixed cable 40 is plugged into a phone jack of an amplifier or PA system, and the extendible cable 50 is extended to a desired length, the phone plug 54 at its free end 52 being then plugged into a musical instrument, such as an electric guitar. The mounting loop 70 allows the housing 20 to be anchored to a point near the phone jack, preventing the phone plug 44 from being pulled free from its connection as the extendible cable 50 is pulled from the housing 20. The mounting loop 70 is preferably pivotally mounted to the housing 20 so that the housing 20 may be anchored in a variety of orientations.

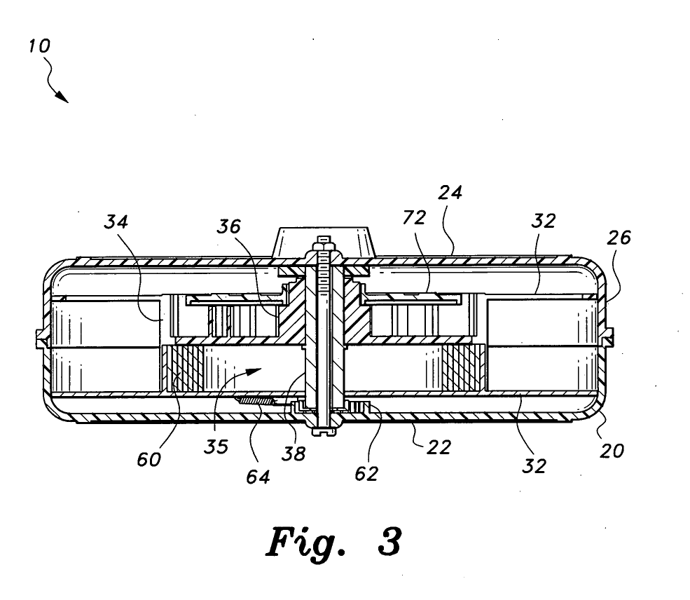

Turning now to FIGS. 2 and 3, the extendible musical instrument cable 10 is shown in greater detail. The housing 20 comprises first and second sidewalls 22, 24 and a peripheral wall 26, the walls defining a housing 20 having generally a flat, cylindrical shape. The housing 20 is assembled from two mating halves 21a, 21b, each of the mating halves 21a, 21b having a sidewall and a peripheral edge 25a, 25b, the peripheral edges 25a, 25b together forming the peripheral wall 26 when the mating halves 21a, 21b are joined. The mounting loop 70 is disposed on the peripheral wall 26 of the housing 20. An opening 28 is defined in the peripheral wall 26. A reel 30 is rotatably mounted between the sidewalls 22, 24, the reel 30 holding a length of electrical cable.

The reel 30 has a first sidewall 32 and a second sidewall 33, both of the sidewalls 32, 33 being circular. The sidewalls 32, 33 are separated by an outer hub wall 34 and an inner hub 36, there being a hollow hub interior 35 defined between the inner hub 36 and the outer hub wall 34. An axle 38 extends through the inner hub 36, and the reel 30 is rotatably supported within the housing 20 by the axle 38. A spring 60 is disposed within the hollow hub interior 35 in connection with the reel 30 and with the axle 38, whereby the spring 60 is wound as the reel 30 is rotated in a first direction.

A releasable ratchet assembly controls the rotation of the reel 30 in a second direction, opposite the first direction, unwinding the spring 60. The ratchet assembly includes a ratchet gear 62 disposed on the inside face of the first sidewall 22 of the housing 20, and a spring-biased pawl 64 disposed on the outer surface of the first sidewall 32 of the reel 30. It can be understood that as the extendible cable 50 is pulled from the reel 30, the reel 30 rotates winding the spring 60, thereby increasing the rotational bias on the reel 30. The ratchet assembly holds the reel 30 in place until released, allowing the length of the extendible cable 50 to remain extended. When the ratchet assembly is released, the spring 60 causes the reel 30 to rotate to rewind the extendible cable 50 onto the reel 30.

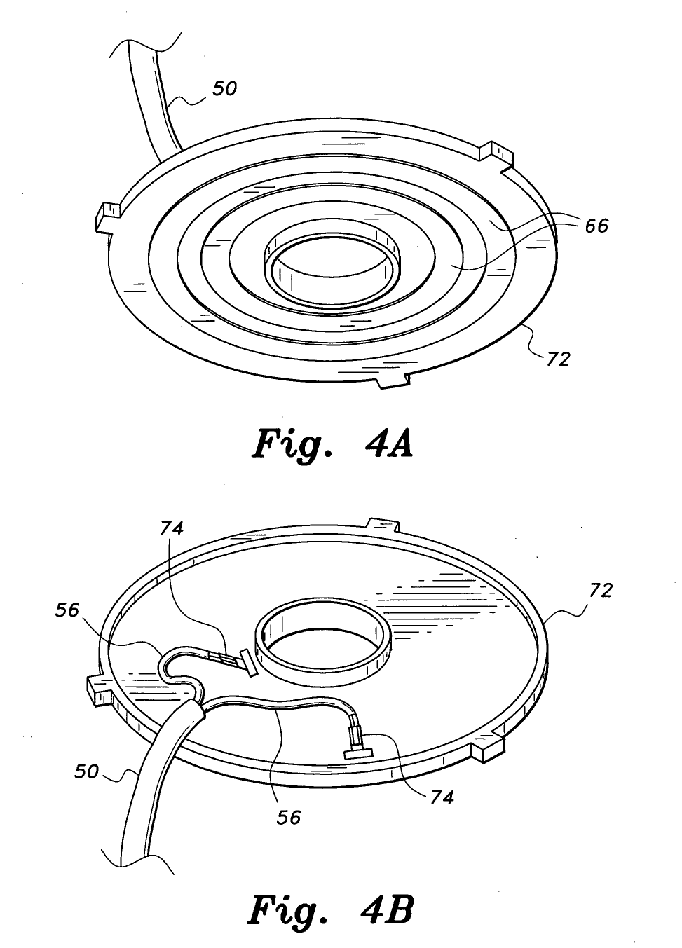

A pair of concentric circular slip ring contacts 66 are disposed on the outer surface of the second sidewall 33 of the reel 30, and are in electrical connection with a pair of wiper contacts 68 disposed in the inside surface of the second sidewall 24 of the housing 20. The extendible cable 50 is electrically connected to the slip ring contacts 66. In the illustrated embodiment, the slip ring contacts 66 are disposed on a removable insert portion 72 of the second sidewall 33 to facilitate wiring of the device. The removable insert portion 72 is shown in greater detail in FIGS. 4A and 4B. Wiring terminals 74 extend through the removable insert portion 72 to the slip ring contacts 66. The individual conductors 56 of the extendible cable 50 are connected to the slip ring contacts 66 via the wiring terminals 74.

The fixed cable 40 extends from the second sidewall 24 of the housing 20, the fixed cable 40 passing through a small aperture in the second sidewall 24 of the housing 20. Wiper contacts 68 are disposed in the inside surface of the second sidewall 24 of the housing 20. The fixed cable 40 is electrically connected to the wiper contacts 68, thereby bringing the fixed cable 40 and the extendible cable 50 into electrical connection.

It is to be understood that the present invention is not limited to the embodiment described above, but encompasses any and all embodiments within the scope of the following claims.

I claim:

1. An extendible musical instrument cable, comprising:
a housing having a pair of parallel sidewalls and a peripheral wall, the peripheral wall having an opening defined therein;
a mounting loop disposed on said housing;
a reel rotatable mounted between the sidewalls of said housing;
biasing means for biasing said reel in a first rotational direction;
ratchet means for controlling rotation of said reel in a second rotational direction opposite said first rotational direction;
a first electrical cable extending from one of said sidewalls, the first electrical cable having first and second ends; and
a second electrical cable having first and second ends, the first end being coiled about said reel and in electrical communication with the first end of said first electrical cable, the second end of the second electrical cable extending from the opening defined in the peripheral wall of said housing.

2. The extendible musical instrument cable according to claim 1, further comprising an electrical connector connected to the second end of said first electrical cable.

3. The extendible musical instrument cable according to claim 1, further comprising an electrical connector connected to the second end of said second electrical cable.

4. The extendible musical instrument cable according to claim 1, wherein said mounting loop is pivotally mounted to said housing.

5. The extendible musical instrument cable according to claim 1, wherein said mounting loop is disposed on the peripheral wall of said housing.

6. An extendible musical instrument cable, comprising:
a housing having a pair of parallel sidewalls and a peripheral wall, the peripheral wall having an opening defined therein;
a mounting loop disposed on said housing;
a reel rotatably mounted between the sidewalls of said housing;
biasing means for biasing said reel in a first rotational direction;
ratchet means for controlling rotation of said reel in a second rotational direction opposite said first rotational direction;
a first electrical cable extending from one of said sidewalls, the first electrical cable having first and second ends;
a second electrical cable having first and second ends, the first end being coiled about said reel and in electrical communication with the first end of said first electrical cable, the second end of the second electrical cable extending from the opening defined in the peripheral wall of said housing;
a first electrical connector connected to the second end of said first electrical cable; and
a second electrical connector connected to the second end of said second electrical cable.

7. The extendible musical instrument cable according to claim 6, wherein said first electrical connector is a phone plug.

8. The extendible musical instrument cable according to claim 6, wherein said second electrical connector is a phone plug.

9. The extendible musical instrument cable according to claim 6, wherein said mounting loop is pivotally mounted to said housing.

10. The extendible musical instrument cable according to claim 6, wherein said mounting loop is disposed on the peripheral wall of said housing.

11. An extendible musical instrument cable, comprising:
a housing having a pair of parallel sidewalls and a peripheral wall, the peripheral wall having an opening defined therein;
a mounting loop pivotally mounted on said peripheral wall;
a reel rotatably mounted between the sidewalls of said housing;
biasing means for biasing said reel in a first rotational direction;
ratchet means for controlling rotation of said reel in a second rotational direction opposite said first rotational direction;
a first electrical cable extending from one of said sidewalls, the first electrical cable having first and second ends;
a second electrical cable having first and second ends, the first end being coiled about said reel and in electrical communication with the first end of said first electrical cable, the second end of the second electrical cable extending from the opening in said peripheral wall of said housing.

12. The extendible musical instrument cable according to claim 11, further comprising an electrical connector connected to the second end of said first electrical cable.

13. The extendible musical instrument cable according to claim 11, further comprising an electrical connector connected to the second end of said second electrical cable.
